(19) United States
(12) Patent Application Publication
(10) Pub. No.: US 2007/0157993 A1
(43) Pub. Date: Jul. 12, 2007

(54) Profile router bit and method of preparing the same

(76) Inventor: Young Se Yoon, Incheon (KR)

Correspondence Address: LEE & MORSE, P.C., 3141 FAIRVIEW PARK DRIVE, SUITE 500, FALLS CHURCH, VA, 22042, US

(21) Appl. No.: 11/600,108

(22) Filed: Nov. 16, 2006

(30) Foreign Application Priority Data
Dec. 23, 2005 (KR) 10-2005-0128375

(51) Int. Cl. B27C 5/10; B27G 13/00; B27M 1/08; B27C 1/00; B27C 9/00; B27C 5/00; B27M 1/00

(52) U.S. Cl. 144/371; 144/136.95; 144/241

(57) ABSTRACT

The present invention relates to a profile router bit and a method of preparing the same, including a shank, the profile router bit including a shank connected to a rotating shaft, a plurality of grinding tips radially mounted onto an upper surface of the shank, and a filler coating applied to the upper surface of the shank between the grinding tips.

### BACKGROUND OF THE INVENTION

1. Field of the Invention

The present invention relates to a profile router bit and method of preparing the same. In particular, the present invention relates to a profile router bit providing minimized vibrations during grinding and cutting processing.

2. Discussion of the Related Art

In general, cutting, drilling, or grinding of a workpiece, e.g., stone, wood, and so forth, may be performed to facilitate a variety of construction or design tasks, such as building or furniture construction, interior decoration, and so forth. Many of such tasks may involve formation of three-dimensionally shaped profiles, e.g., tongue-and-groove joints, decorative designs, and so forth, that may require precise and smooth cutting or grinding.

Smooth cutting or grinding may be achieved by specialized, e.g., rotating, cutting tools such as routers. Routers may employ router bits having unique profiles, i.e., profile router bits, such that upon contact with a surface of a desired workpiece, a specific and smooth design may be imparted thereon.

However, conventionally known profile router bits tend to create noise and vibrate and, thereby, reduce the precision and smoothness imparted onto a surface of a workpiece and increase the failure potential of the profile router bit. Accordingly, there remains a need for profile router bits providing minimized vibrations during grinding and cutting processing.

### SUMMARY OF THE INVENTION

The present invention is therefore directed to a profile router bit and method of preparing the same, which substantially overcome one or more of the problems due to the limitations and disadvantages of the related art.

It is therefore a feature of an embodiment of the present invention to provide a profile router bit providing minimized noise and vibration.

It is another feature of an embodiment of the present invention to provide a method of preparing a profile router bit having enhanced efficiency due to minimized noise and vibration.

At least one of the above and other features and advantages of the present invention may be realized by providing a profile router bit, including a shank connected to a rotating shaft, a plurality of grinding tips radially mounted onto an upper surface of the shank, and a filler coating applied to the upper surface of the shank between the grinding tips.

The profile router bit of the present invention may further include a connecting device. Additionally, the profile router bit may include a bearing. The shank of the inventive profile router bit may include a bore.

The grinding tips may be disposed in equal intervals. Additionally, the grinding tips may be formed of a mixture containing metal and diamond. The metal may be cobalt (Co), copper (Cu), tin (Sn), iron (Fe), zinc (Zn), nickel (Ni), or a mixture thereof. In particular, the metal may include from about 30% to about 40% by weight of cobalt, from about 30% to about 40% by weight of copper, from about 10% to about 15% by weight of tin, from about 10% to about 15% by weight of iron, from about 3% to about 5% by weight of zinc, and from about 3% to about 5% by weight of nickel.

The filler coating may be formed to have a thickness equal to a height of the grinding tips. The filler coating may also include epoxy resin, phenol resin or a mixture thereof. Additionally, the filler coating may include diamond, tungsten carbide, silicate carbide, aluminum oxide, or a mixture thereof. In particular, the filler coating may include from about 60% to about 80% by weight of epoxy resin, from about 15% to about 25% by weight of phenol resin, and from about 10% to about 20% by weight of tungsten carbide.

In another aspect of the present invention, there is provided a method of producing a profile router bit, including mixing metal and abrasive material to form a mixture, mixing filler components to form a filler coating, injecting the mixture into a mold to form a plurality of grinding tips, sintering the mold, cooling the mold, separating the grinding tips from the mold, welding the plurality of grinding tips to a shank, applying the filler coating to the shank between the plurality of grinding tips to form a router bit, thermosetting the router bit, and post-processing the router bit to form a profile router bit.

Injecting the mixture into a released mold may include setting in a carbon mold. Sintering the mold may include setting a pressure range from about 200 Kg/cm² to about 300 Kg/cm² and a temperature range from about 700° C. to about 800° C.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a perspective view of a profile router bit according to an embodiment of the present invention;

FIG. 2 illustrates a cross-sectional view of a profile router bit taken along line A-A′ in FIG. 1;

FIGS. 3A-3G illustrate perspective views of profile router bits according to other embodiments of the present invention;

FIG. 4 illustrates a perspective view of a grinding tool employing a profile router bit according to an embodiment of the present invention; and

FIG. 5 illustrates perspective views of workpieces processed with a profile router bit according to an embodiment of the present invention;

FIG. 6 illustrates a block diagram of a preparation method of a profile

### DETAILED DESCRIPTION OF THE INVENTION

Korean Patent Application No. 10-2005-0128375, filed on Dec. 23, 2005, in the Korean Intellectual Property Office, and entitled: “Profile Router Bit and the Preparing Method of the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer, element, or substrate, or intervening layers or elements may also be present. Further, it will be understood that when a layer or element is referred to as being “under” another layer or element, it can be directly under, or one or more intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

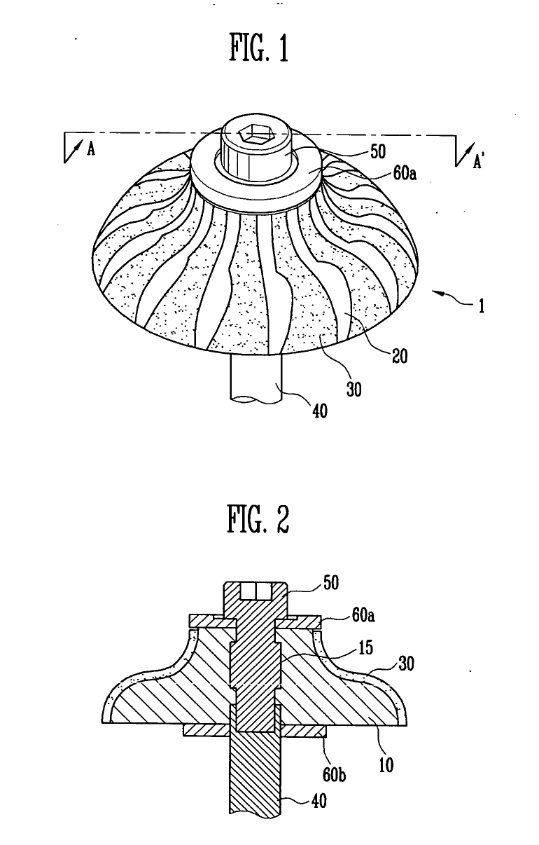

An exemplary embodiment of a profile router bit according to the present invention is more fully described below with reference to FIGS. 1-2. As illustrated in FIGS. 1-2, a profile router bit 1 according to an embodiment of the present invention may include a shank 10 coupled to a rotating shaft 40, a plurality of grinding tips 20, and a filler coating 30.

The shank 10 of the profile router bit 1 may be formed in any suitable form known in the art, and one of ordinary skill in the art may determine the shape thereof with respect to an intended workpiece. The shank 10 may be formed of metal, and it may have a bore 15 formed through its center.

The shank 10 may be attached to the rotating shaft 40 to facilitate rotation thereof. The attachment of the shank 10 to the rotating shaft 40 may be performed by any method known in the art. For example, the shank 10 may be attached to the rotating shaft 40 through the bore 15 by a connecting device, such as a bolt 50, a screw (not shown), and so forth. In particular, the bolt 50 and the rotating shaft 40 may be inserted into the bore 15 of the shank 10 from opposite directions to form a connection therebetween and, thereby, couple the shank 10 to the rotating shaft 40 via the bore 15. In this regard it should be noted that the respective lengths of the rotating shaft 40 and the bolt 50 may be adjusted by one of ordinary skill in the art with respect to the size of the profile router bit 1 and other processing requirements. Further, it should be noted that other attachment methods, e.g., connecting the rotating shaft 40 and the bolt 50 outside of the bore 15, employing Computer Numerical Control (CNC) to connect the rotating shaft 40 directly to the shank 10, and so forth, are not excluded from the scope of this invention.

In order to facilitate rotation of the shank 10, the profile router bit 1 may also include a bearing 60a and a coupling member 60b. The bearing 60a may be inserted through the rotating shaft 40 and positioned on a top of the shank 10, thereby facilitating rotation of the shank 10. As illustrated in FIG. 2, the bearing 60a may be positioned between the bolt 50 and the shank 10. The bearing 60a may also facilitate uniform processing of a workpiece, i.e., bearing 60a may provide constant grinding depth and movement along the surface of the workpiece. The coupling member 60b may be inserted through the rotating shaft 40 and positioned below the shank 10 to provide improved fit of the rotating shaft 40 to the bore 15 and, thereby, minimize shaking and vibrations of the rotating shaft 40 during processing.

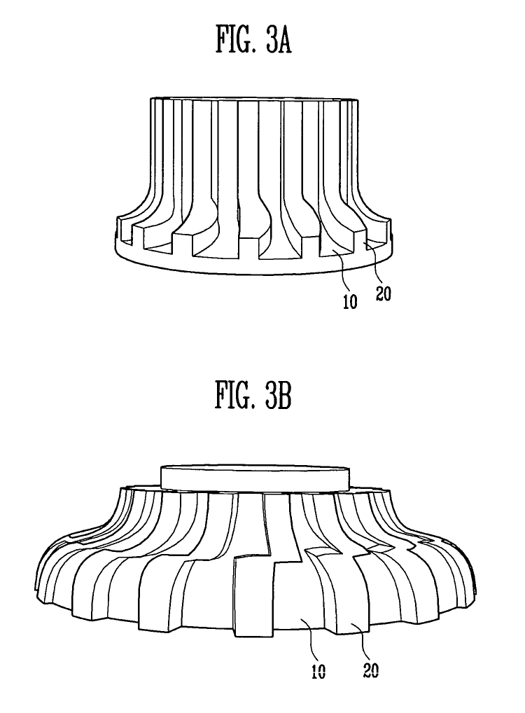

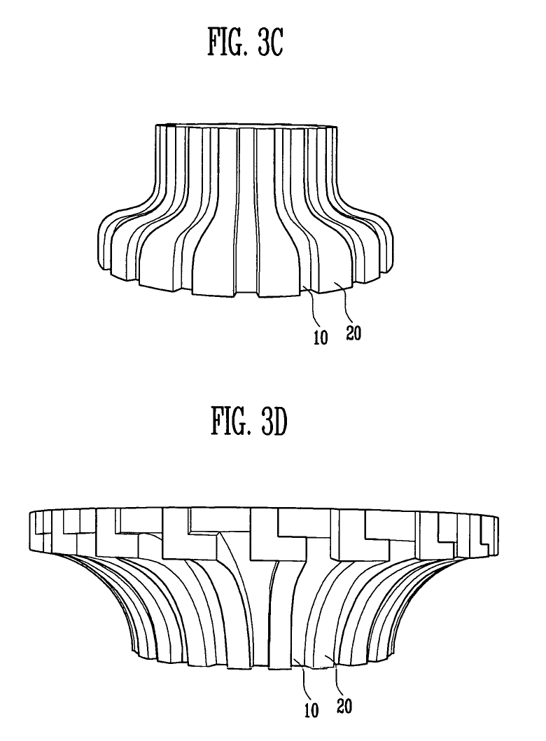

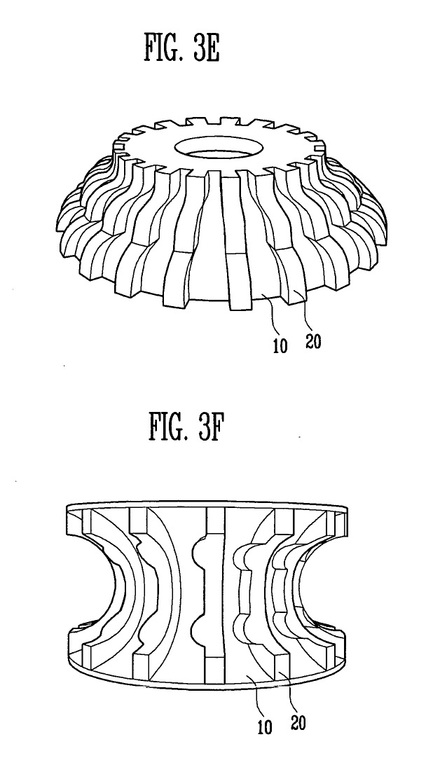

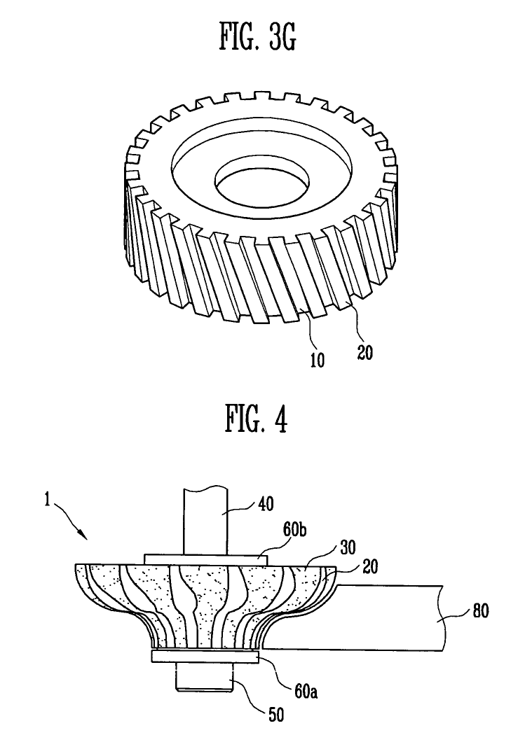

The plurality of grinding tips 20 of the profile router bit 1 according to an embodiment of the present invention may be formed in any suitable number, height, or form, e.g., ridges, known in the art or determined by one of ordinary skill in the art with respect to the a desired design of a workpiece. The plurality of grinding tips 20 may be mounted onto an outer surface of the shank 10 in a radial direction with respect to the center of the shank 10. Preferably, the plurality of grinding tips 20 may have equal intervals therebetween upon attachment to the shank 10. FIGS. 3A-3G illustrate exemplary embodiments of assembling various structures of shanks 10 and plurality of grinding tips 20 to form profile router bits according to an embodiment of the present invention. In particular, FIG. 3A-3G illustrate profile router bits having an A-shape, an F-shape, an FS-shape, an H-shape, a Q-shape, and a Z-shape, respectively.

The plurality of grinding tips 20 may be formed of a material composition containing a mixture of a metal and an abrasive material, i.e., a material having high hardness values, such as diamond. In this respect, it should be noted that “hardness,” “hardness properties,” and like terminology with respect to the present invention refers to material property as determined with respect to Brinell Hardness Scale according to an EN ISO 6506-1 test or an ASTM E10 test, or as determined with respect to Rockwell Hardness Scale according to an ISO 6508-1 test or an ASTM E18 test. In this respect, it should also be noted that increased amounts or concentrations of abrasive material in any parts of the profile router bit 1 of the present invention may indicate increased hardness.

Preferred metals employed in formation of the grinding tips 20 may include, but are not limited to cobalt (Co), copper (Cu), tin (Sn), iron (Fe), zinc (Zn), nickel (Ni), or a mixture thereof. For example, if a mixture of metals is used, a preferred composition may include from about 30% to about 40% by weight of cobalt, from about 30% to about 40% by weight of copper, from about 10% to about 15% by weight of tin, from about 10% to about 15% by weight of iron, from about 3% to about 5% by weight of zinc, and from about 3% to about 5% by weight of nickel.

The filler coating 30 of the profile router bit 1 according to an embodiment of the present invention may be applied onto the upper surface of the shank 10, in the spaces formed between the grinding tips 20, as illustrated in FIGS. 1-2. In particular, the filler coating 30 may fill the spaces between the grinding tips 20 completely, thereby assuming the shape formed between the grinding tips 20. Further, it may be preferable to form a filler coating 30, such that it has a thickness that is equal to the height of the grinding tips 20.

The filler coating 30 may be formed of a relatively soft material as compared to the material composition forming the grinding tips 20, i.e., a material having reduced hardness. Without intending to be bound by theory, it is believed that spaces between the grinding tips 20 may be provided to remove, i.e., cut and/or grind portions of the workpiece during processing. Accordingly, application of relatively softer material as filler coating 30 may maintain the cutting and grinding ability of the grinding tips 20, while minimizing roughness thereof. In particular, the filler coating 30 may enhance smoothness of the processed workpiece and reduce the grinding noise during processing.

Preferred materials to be employed as filler coating 30 may include, but are not limited to, epoxy resin, phenol resin, mixtures thereof, and so forth. The filler coating 30 may also include additives such as tungsten carbide, silica carbide, boron nitride, aluminum oxide, mixtures thereof, and so forth, to improve abrasion-resistance of the filler coating 30. For example, if a mixture of materials is used to form the filler coating 30, a preferred composition may include from about 60% to about 80% by weight of epoxy resin, from about 15% to about 25% by weight of phenol resin, and from about 10% to about 20% by weight of tungsten carbide.

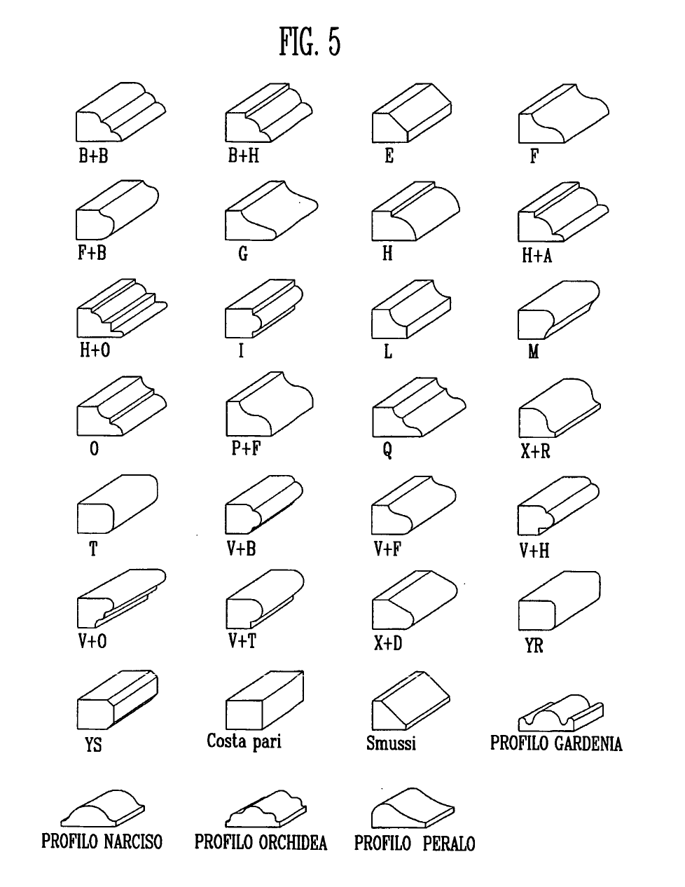

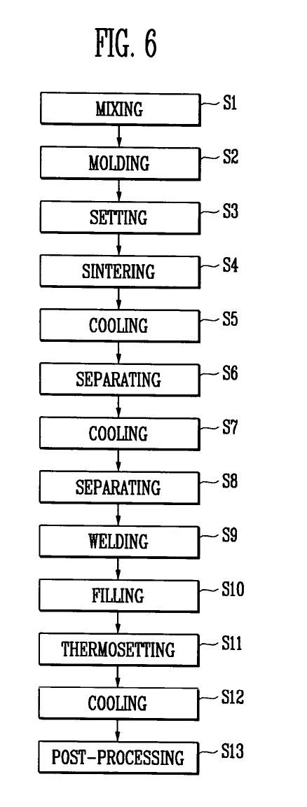

The profile router bit 1 according to an embodiment of the present invention may be integrated in a cutting tool (not shown) and contacted with a workpiece 80, as illustrated in FIG. 4, for processing and imparting a design thereon. In particular, the profile router bit 1 may be assembled by attaching the rotating shaft 40 to the shank 10 and securing the attachment with the bolt 50 and the bearing 60a. Such attachment may be facilitated by connecting the rotating shaft 40 and the bolt 50 via the bore 15. However, other connection methods are not excluded from the scope of this application. In this regard, it should also be noted that the shank 10 may be previously processed to include grinding tips 20 and filler coating 30 as will be discussed below with respect to FIG. 6.

Operation of a motor (not shown) may rotate the rotating shaft 40, thereby transferring its rotational motion to the shank 10 and, thereby, to the profile router bit 1. Rotation of the profile router bit 1, while in contact with workpiece 80, may impart a design thereon. The design imparted onto the workpiece 80 may correspond to the shape of the grinding tips 20 of the profile router bit 1. Exemplary processed workpieces with the profile router bit 1 of the present invention are illustrated in FIG. 5.

In accordance with another embodiment of the present invention, a method of preparing a profile router bit discussed previously with respect to FIGS. 1-5 will be discussed in detail below with respect to FIG. 6. Accordingly, it should be noted that descriptions of the particular elements of the profile router bit 1 will not be repeated herein.

Formation of a profile router bit 1 according to an embodiment of the present invention may include eleven sequential steps. In particular, the formation process may include a mixing step S1, a molding step S2, a setting step S3, a sintering step S4, a cooling step S5, a separating step S6, a welding step S7, a filling step S8, a thermosetting step S9, a cooling step S10, and a post-processing step S11.

First, the mixing step S1 may include mixing the material compositions of the grinding tips 20 and the filler coating 30 at predetermined proportions, respectively, with a mixer. Next, each part of the profile router bit 1, i.e., the shaft 10 and the grinding tips 20, may be molded by any molding process-known in the art by injecting respective mixed mixtures into a mold to form the desired shapes. This step may be referred to as the molding step S2. Once molding is complete, each component may be set by placement in a carbon mold for a predetermined amount of time as a setting step S3.

Subsequently, in the sintering step S4, the carbon molds from the previous step may be transferred into a fire furnace, where specified pressure, temperature and nitrogen/hydrogen may be applied for a predetermined amount of time to perform sintering. In particular, the preferred sintering temperature may range from about 700° C. to about 800° C., the sintering pressure may range from about 200 Kg/cm² to about 300 Kg/cm², and the sintering flow of nitrogen gas may be about 30 Nm³/hr. The predetermined amount of time may be about 1 hr. Alternatively, the carbon molds may be placed in a tunnel-type fire furnace to provide natural shrinkage due to sintering at reductive atmosphere.

Next, the sintered carbon molds may be transferred into a cooling press for a predetermined amount of time in a cooling step S5. In particular, the preferred cooling pressure may range from about 300 Kg/cm² to about 350 Kg/cm², the flow of nitrogen gas may be about 30 Nm³/hr, and the predetermined amount of time may be about 1 hr.

At the completion of the cooling step S5, each segment may be separated from its respective carbon mold in a separating step S6. Next the shank 10 and the grinding tips 20 may be welded together to form a router bit in a welding step S7. The welding step S7 may be performed by any welding process known in the art, such as high frequency welding, laser welding, oxygen torch welding, and so forth.

Subsequently, in a filling step S8, the router bit may be charged into a steel mold, and the filler coating mixture prepared in the mixing step S1 may be applied thereto to fill the spaces between the grinding tips 20.

Next, the steel mold processed in the filling step S8 may be placed into a thermosetting press for a predetermined amount of time to allow thermosetting of the filler coating 30 in a thermosetting step S9. In particular, the preferred thermosetting temperature may range from about 120° C. to about 160° C., and the predetermined amount of time may range from about 30 minutes to about 60 minutes.

Once the thermosetting step S9 is complete, the steel mold may be pulled out the thermosetting press to cool it with water and air in a cooling step S10. It may be preferable that the cooling step S10 may range from about 10 minutes to about 30 minutes.

Finally, in a post-processing step S11, the cooled steel mold containing the router bit may be removed to facilitate post-processing of the router bit to form a profile router bit.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A profile router bit, comprising:
a shank connected to a rotating shaft;
a plurality of grinding tips radially mounted onto an upper surface of the shank; and
a filler coating on the upper surface of the shank between the grinding tips.

2. The profile router bit as claimed in claim 1, wherein the shank includes a bore.

3. The profile router bit as claimed in claim 1, further comprising a connecting device.

4. The profile router bit as claimed in claim 1, further comprising a bearing.

5. The profile router bit as claimed in claim 1, wherein the grinding tips are disposed at equal intervals.

6. The profile router bit as claimed in claim 1, wherein the grinding tips comprise a mixture including metal and diamond.

7. The profile router bit as claimed in claim 6, wherein the metal includes cobalt (Co), copper (Cu), tin (Sn), iron (Fe), zinc (Zn), nickel (Ni), or a mixture thereof.

8. The profile router bit as claimed in claim 7, wherein the metal includes from about 30% to about 40% by weight of cobalt (Co), from about 30% to about 40% by weight of copper (Cu), from about 10% to about 15% by weight of tin (Sn), from about 10% to about 15% by weight of iron (Fe), from about 3% to about 5% by weight of zinc (Zn), and from about 3% to about 5% by weight of nickel (Ni).

9. The profile router bit as claimed in claim 1, wherein the filler coating has a thickness equal to a height of the grinding tips.

10. The profile router bit as claimed in claim 1, wherein the filler coating includes epoxy resin, phenol resin or a mixture thereof.

11. The profile router bit as claimed in claim 10, wherein the filler coating further includes diamond, tungsten carbide, silicate carbide, aluminum oxide, or a mixture thereof.

12. The profile router bit as claimed in claim 11, wherein the filler coating includes from about 60% to about 80% by weight of epoxy resin, from about 15% to about 25% by weight of phenol resin, and from about 10% to about 20% by weight of tungsten carbide.

13. A method of producing a profile router bit, comprising:
mixing metal and abrasive material to form a mixture;
mixing filler components to form a filler coating;
injecting the mixture into a mold to form a plurality of grinding tips;
sintering the mold;
cooling the mold;
separating the grinding tips from the mold;
welding the plurality grinding tips to a shank;
applying the filler coating to the shank between the grinding tips to form a router bit;
thermosetting the router bit; and
post-processing the router bit to form a profile router bit.

14. The method as claimed in claim 13, wherein injecting the mixture into a released mold includes setting in a carbon mold.

15. The method as claimed in claim 13, wherein sintering the mold includes setting a pressure range from about 200 Kg/cm² to about 300 Kg/cm² and a temperature range from about 700° C. to about 800° C.
